(19) United States
(12) Patent Application Publication
(10) Pub. No.: US 2011/0137517 A1
(43) Pub. Date: Jun. 9, 2011

(54) METHOD FOR INDICATING A DISCREPANCY FOR DRIVING DATA IN A MOTOR VEHICLE, AND SYSTEM FOR CARRYING OUT THE METHOD

(75) Inventors: Gunnar SCHMIDT, Villingen-Schwenningen (DE); Edmund Mattes, Spaichingen (DE); Michael Gut, Braeunlingen (DE)

(73) Assignee: Continental Automotive GmbH, Hannover (DE)

(21) Appl. No.: 12/962,167

(22) Filed: Dec. 7, 2010

(30) Foreign Application Priority Data
Dec. 7, 2009 (DE) 10 2009 056 964.2

(51) Int. Cl. G06F 7/00

(52) U.S. Cl. 701/33

(57) ABSTRACT

A method and system for indicating a discrepancy between driving data captured using a tachograph and at least one prescribed rule by an indicator appliance independent of the tachograph. The indicator appliance is connected to a tachograph data memory that has the driving data. By virtue of detachable electromechanical coupling of the indicator appliance to the tachograph data memory that is automatically followed by at least one driving data volume element being loaded into an appliance data memory of the indicator appliance and automatically compared with at least one rule. The presence of a discrepancy between the loaded driving data volume element and the rule prompts the presence of the discrepancy to be transmitted to a user of the indicator appliance as a violation report.

### BACKGROUND OF THE INVENTION

1. Field of the Invention

The invention relates to a method for indicating a discrepancy between driving data in a motor vehicle captured using a tachograph and at least one prescribed rule by an indicator appliance independent of the tachograph. In addition, the invention relates to a system for carrying out such a method.

2. Description of the Related Art

An arrangement having a mobile data storage medium and a handheld appliance for indicating driving periods, rest periods and other types of activity which can be recorded by a tachograph during operation of a motor vehicle is described in WO 2007/031460 A1. The handheld appliance is not particularly well suited to use for traffic inspections, particularly queue inspections, due to the extensive operator control which is required. The same applies to a portable tachograph as known from DE 103 34 461 A1.

### SUMMARY OF THE INVENTION

It is an object of one embodiment of the invention to specify a method of the type cited at the outset which is fast and reliable. In addition, it is an object of the invention to provide a system which is suitable for carrying out a method as cited above.

According to one embodiment of the invention, a method of the type cited at the outset is disclosed, wherein the indicator appliance is connected to a tachograph data memory of the tachograph, which tachograph data memory has the driving data. By virtue of detachable electromechanical coupling of the indicator appliance either to the tachograph or to a card reader, which can be connected to the tachograph data memory, the connection is automatically followed by at least one driving data volume element to be examined in the driving data being loaded from the tachograph data memory into an appliance data memory of the indicator appliance and being automatically compared with the at least one rule by an appliance microprocessor of the indicator appliance, and wherein the presence of a discrepancy between the loaded driving data volume element and the rule prompts the presence of the discrepancy to be automatically and nonquantitatively transmitted to a user of the indicator appliance by an indicator unit of the indicator appliance as a violation report.

A particular advantage of the method according to one embodiment of the invention is that the user does not need to make any kind of inputs into the indicator appliance, but rather the method takes place totally automatically. The only requirement is establishing the electromechanical coupling between indicator appliance and tachograph or card reader. Besides the automatic execution of the method, the nonquantitative—that is to say that it does not contain any information relating to volume—transmission of the violation report, in particular, which transmission therefore does not require evaluation by the user and provides the latter with a clear and unequivocal result for the check on the presence of a discrepancy, advantageously allows very fast and reliable method execution. The nonquantitative transmission consists in yes/no signaling in the simplest case. If the method is used by a collaborator from inspection authorities for the purpose of monitoring, a motor vehicle and a driver—for which a check on the driving data does not establish a control error and hence does not involve the transmission of a violation report—can continue their journey after only a short interruption; if, on the other hand, a control violation is established and a violation report transmitted, a further—in that case more time-consuming—method step can be used to check the driving data in detail, for example by virtue of the driving data being printed by means of a printer in the tachograph and the printout being evaluated or by virtue of the driving data being evaluated on a mobile data processing apparatus, for example a notebook.

Since the invention requires such complex detailed evaluation only in cases in which there has actually been a violation report, it is very advantageously possible to perform significantly more inspections in a particular unit of time given the same number of inspection collaborators; drivers and vehicles for which there is no violation report need to interrupt their driving assignment only briefly, and time-consuming detailed inspections are not required in this case. In comparison with the methods known from the prior art, the method according to the invention is very fast and thereby allows a large number of inspections in a short time. Furthermore, it does not require any complex operator control and therefore not only protects against operator control errors but also contributes to further speeding-up of the process. Advantageously, a violation report—for example by a data processing apparatus which is independent of the tachograph and of the indicator appliance—is followed directly by a detailed analysis of the driving data which have been loaded into the indicator appliance and examined, with a detailed examination of the discrepancy from the rule. The driving data affected by the invention and captured by a tachograph is not only data that relates directly to the motor vehicle moving or not moving, such as speed data or vehicle standstill data, but rather are, in principle, all data captured via the tachograph; in particular, the driving data also include data relating to manipulative violations, such as manipulations and manipulation attempts on the tachograph itself, for example illegal opening of a tachograph casing. In principle, the volume of driving data to be examined in accordance with the invention may include the total volume of driving data in the tachograph data memory; in order to speed up the process, however, provision may be made for only a driving data volume element, for example covering the last 24 hours or the last seven days, to be loaded into the indicator appliance and examined.

In one embodiment, the indicator unit has a sound radiating element and that the violation report is transmitted audibly. However, it is of great advantage, particularly for rapid and reliable comprehension of the violation report by the user, particularly an inspection collaborator—performing an inspection assignment—from inspection authorities, if, in accordance with one development of the invention, the presence of the discrepancy is transmitted to the user visually. Particularly when the method according to the invention is used in a loud environment, as is regularly found in the case of inspections on highways or heavily frequented arterial highways, for example, visual transmission is particularly advantageous. One very simple option is for the indicator unit to have a single light-emitting element therefore which lights up in order to transmit the violation report, the attentiveness effect being able to be heightened by an additional flashing effect, for example.

In line with another advantageous development of the invention, a correspondence report is automatically and nonquantitatively transmitted to the user by the indicator unit if there is no discrepancy between the loaded driving data volume element and the rule. This makes the checking result even faster and more reliable for the user to comprehend. In the case of visual transmission, the correspondence report may involve the light-emitting means lighting up without interruption and the violation report may involve the light-emitting means lighting up in a flashing mode, for example.

To obtain more precise information without reducing the speed of execution of the method, it is advantageous if, in line with another development of the invention, at least two different types of discrepancies from rules are provided and if the violation report is made in a manner differentiated according to type. By way of example, one type of discrepancy may be when a permissible driving period is exceeded. Another type of discrepancy may be an indication of illegal manipulation of the tachograph and/or of the driving data, for example. Another type of discrepancy may be when a permissible maximum speed of the motor vehicle is exceeded, for example; this permissible maximum speed may be conditional upon design, for example, that is to say dependent on the design of the motor vehicle (for example 80 km/h), or, by way of example, it may be a, possibly adjustable, permissible maximum speed below that (for example 60 km/h) which, in a particular time window, for example, allows a violation check for a route section with a speed limit, for example roadworks with a speed limit through which the motor vehicle has traveled.

In line with another advantageous development of the invention, at least one rule comprises a limit value and the discrepancy from the rule consists in the limit value being exceeded or undershot. By way of example, the limit value may be the permissible maximum speed of the motor vehicle which is conditional upon design or—as described above—a possibly adjustable maximum speed below that, for example.

In one embodiment, the at least one rule with which the driving data is compared is stored in unalterable form in the indicator appliance, for example in the appliance microprocessor or an appliance data memory connected thereto. However, in order to allow adjustment to suit rule changes and convenient handling of the method, it is of particular advantage if, in line with another development of the invention, before the indicator appliance is connected to the tachograph data memory the indicator appliance is connected to a data processing apparatus which is independent of the tachograph and if adjustment by means of the data processing apparatus prescribes the at least one rule, the indicator appliance being disconnected from the data processing apparatus following the adjustment. Preferably, the data processing apparatus may be a mobile data processing apparatus, for example a notebook; in principle, however, it may also be a static data processing apparatus.

It is conceivable for the detachable electromechanical coupling of the indicator appliance to be made directly to the tachograph, for example by a front interface on the tachograph. However, this fundamentally requires the inspection collaborator to get into the motor vehicle and make the coupling. The method according to the invention can be speeded up further if, in line with another advantageous development of the invention, the tachograph data memory is a memory card which can be removed from the tachograph, if the memory card removed from the tachograph is inserted into the card reader, which is independent of the tachograph and of the indicator appliance, and if the indicator appliance is connected to the memory card by means of the card reader. The memory card is preferably a tachograph card, particularly a driver card.

In line with another advantageous development of the invention, the at least driving data volume element loaded into the indicator appliance is stored in an appliance data memory of the indicator appliance, which appliance data memory is in the form of an interchangeable memory. This provides the option—which is advantageous particularly when there is a violation report—of removing the interchangeable appliance data memory from the indicator appliance and using it to safeguard evidence, particularly for storage.

The invention achieves the second object mentioned above by means of a system for carrying out a method according to the invention as cited above having a tachograph which is arranged in a motor vehicle and which has a tachograph data memory and having an indicator appliance which is independent of the tachograph and which has an appliance data memory, an appliance microprocessor and an indicator unit, wherein the indicator appliance can be connected to the tachograph data memory for the purpose of automatically downloading driving data for the motor vehicle and is suitable for automatic comparison of the downloaded driving data with a rule and for automatic and nonquantitative transmission of a violation report.

The system according to the invention does not require any input or operating elements, since it ensures automatic method execution. There is therefore no longer any risk of operator control errors, and it is advantageously not possible for the method to be slowed down on account of the need for operator control by the user.

In line with one advantageous development of the invention, the tachograph data memory is a memory card and a card reader is provided for holding the memory card and connection to the indicator appliance. The memory card is a driver card belonging to the driver of the motor vehicle, in particular. This advantageously allows the vehicle driver to be inspected for compliance with social legislation, for example, independently of the motor vehicle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are shown schematically in the drawing and are described in more detail below. In the drawing:

FIG. 1 is a flowchart of a method for indicating a discrepancy for driving data in a motor vehicle;

FIG. 2 is an indicator appliance for indicating the discrepancy;

FIG. 3 is a further illustration of the indicator appliance shown in FIG. 2; and

FIG. 4 is a further flowchart of the method.

### DETAILED DESCRIPTION OF THE PRESENTLY PREFERRED EMBODIMENTS

In all the figures, elements which correspond to one another have respectively been provided with the same reference symbols.

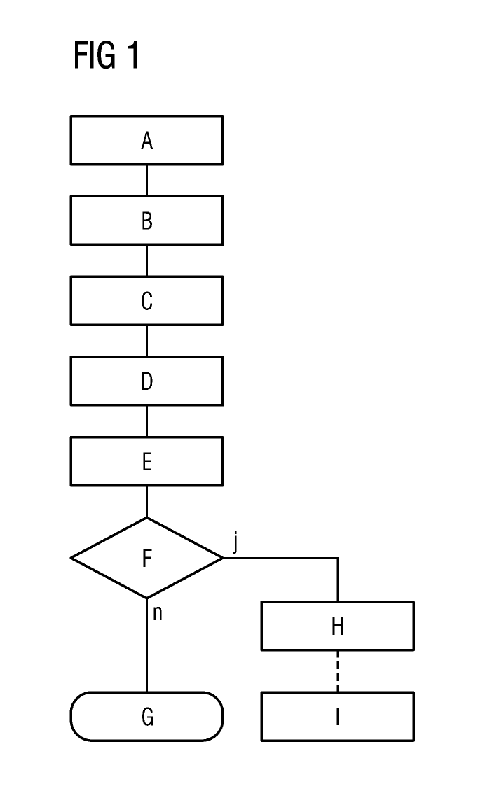

FIG. 1 is a flowchart for the execution of a method for indicating a discrepancy for driving data in a motor vehicle which have been captured using a tachograph. In this case, a first box A involves electromechanical coupling of an indicator appliance either directly to the tachograph or to a card reader which can be connected to the tachograph data memory. In the latter case, the tachograph data memory is a memory card, for example a tachograph card in the form of a driver card.

When the indicator appliance has been connected to the tachograph or to the card reader, a subsequent box B involves automatic download of driving data to the indicator appliance, wherein a further box C involves the downloaded driving data being stored in an appliance data memory of the indicator appliance. The appliance data memory may have an interchangeable memory and/or an internal memory.

In a subsequent box D, the downloaded driving data are automatically evaluated by an appliance microprocessor and, in a further box E, compared with a prescribed rule to determine whether there is a discrepancy, that is to say a violation of the rule, in the loaded driving data, which is shown by the subsequent box F. If there is no violation, a downward-pointing branch n in FIG. 1 is followed, and the method is terminated in a concluding box G.

If, by contrast, there is a violation, a rightward-pointing branch y in FIG. 1 is followed, and a subsequent box H involves a violation report being automatically and nonquantitatively transmitted to a user by an indicator unit of the indicator appliance. A further box I may involve detailed evaluation of the violation, for example using a mobile or static data processing apparatus, for example a notebook or a workstation computer.

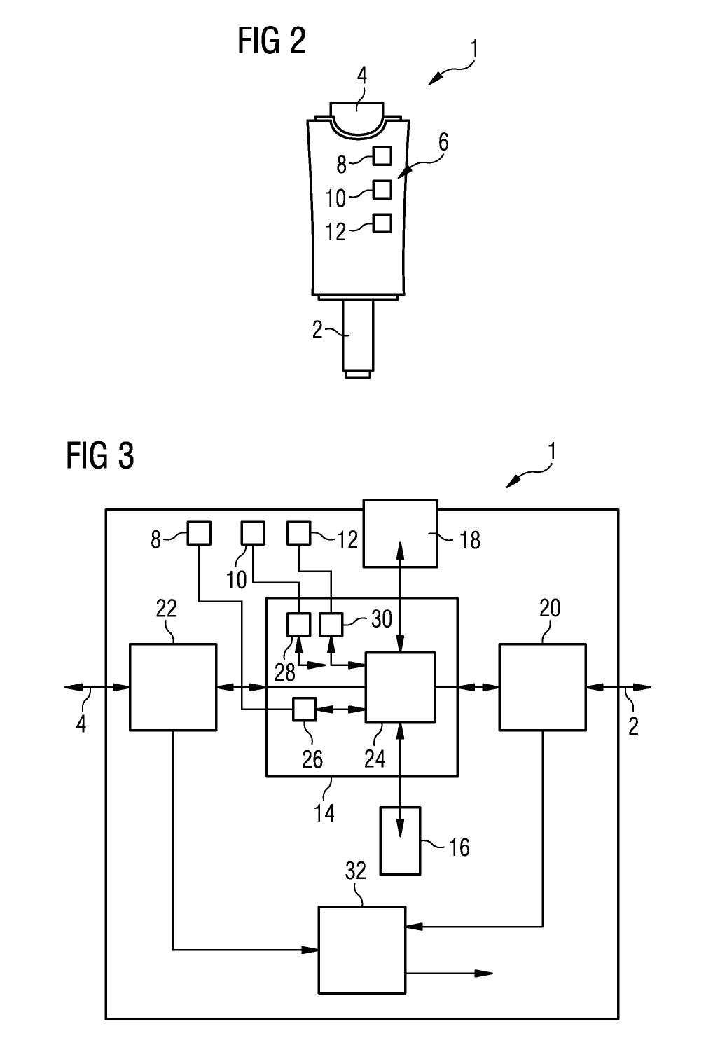

FIGS. 2 and 3 show the indicator appliance 1 by way of example. Said indicator appliance has a first data interface 2 for detachable electromechanical coupling to a tachograph—not shown in the present case—or to a card reader. In this exemplary embodiment, the indicator appliance 1 also has a second data interface 4 for connection to a data processing apparatus—not shown in the presence case; in principle, however, it would also be conceivable to use the first data interface 2 for this purpose. In addition, the indicator appliance 1 has an indicator unit 6 with—in this example—three light-emitting elements 8, 10, 12.

In FIG. 3, it can be seen that the indicator appliance 1 has an appliance microprocessor 14 which is connected, inter alia, to a first appliance data memory 16 in the form of an internal memory and to a second appliance data memory 18 in the form of an interchangeable memory, and also to a first control unit 20 for actuating the first data interface 2 and a second control unit 22 for actuating the second data interface 4.

The appliance microprocessor 14 comprises a flow control unit 24. In accordance with this exemplary embodiment, the flow control unit 24 controls three evaluation units 26, 28, 30 which are likewise part of the appliance microprocessor 14 and which in this case are connected for signaling purposes to a respective one of the light-emitting elements 8, 10, 12 of the indicator unit 6. By way of example, a first evaluation unit 26 and a first light-emitting element 8 are able to establish and transmit a violation of a rule relating to a permissible driving period. A second evaluation unit 28 and a second light-emitting element 10 are able to establish and transmit a violation of a rule relating to an indication of illegal manipulation of the tachograph and/or of the driving data, for example. A third evaluation unit 30 and a third light-emitting element 12 are able to establish and transmit a violation of a rule relating to a permissible maximum speed—which is conditional upon design, for example—of the motor vehicle, for example.

In addition, the indicator appliance 1 contains an internal voltage regulatory unit 32 for regulating the electrical voltage of the elements of the indicator appliance 1. The power supply itself is provided, in principle, via the first data interface 2 and/or the second data interface 4.

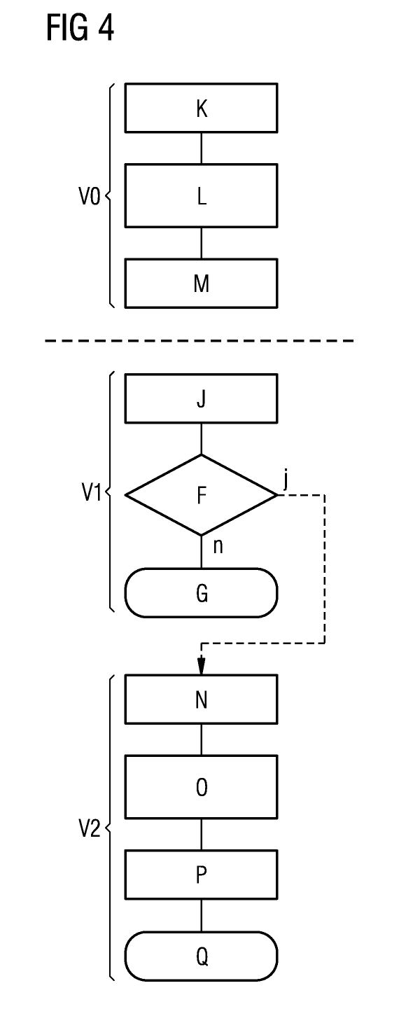

FIG. 4 shows an overview of further possible method elements, inter alia. A central method element V1 shows a summarized form of the method described above for FIG. 1 with appropriate reference symbols, wherein a first box J combines the first five boxes A to E shown in FIG. 1.

A preceding method element V0 may be connected upstream of the central method element V1. The preceding method element V0 provides for the connection of the indicator appliance to the tachograph data memory to be preceded by a first box K involving the indicator appliance being connected to a data processing apparatus which is independent of the tachograph, for example to a workstation computer or to a notebook, by electromechanical coupling by the second data interface 4 of the indicator appliance 1 (FIGS. 2, 3).

A subsequent box L involves adjustment by the data processing apparatus to prescribe the rule with respect to a violation being checked in the central method element. In a box M which concludes the preceding method element V0, the indicator appliance is disconnected from the data processing apparatus.

A subsequent method element V2 may be connected downstream of the central method element V1. The subsequent method element V2 may be a form of the content of box I in FIG. 1 and can be processed in line with branch y when the central method element V1 involves a violation report.

In a first box N of the subsequent method element V2, the indicator appliance is connected to a data processing apparatus which is independent of the tachograph by the second data interface (FIGS. 2, 3). Next, a detailed evaluation and detailed analysis of the discrepancy between the driving data loaded into the indicator appliance for the purpose of checking in method element V1 and the rule take place by and in the data processing apparatus in a subsequent box O. By way of example, there may be a presentation on a screen of the data processing apparatus or a print output of a violation log by a printing device of the data processing apparatus. To safeguard evidence, a subsequent box P can involve the appliance data memory 18 in the form of an interchangeable memory being removed from the indicator appliance 1 (FIG. 3), for example. The subsequent method element V2 is terminated in a concluding box Q following the disconnection of the indicator appliance and the data processing apparatus.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A method for indicating a discrepancy between driving data in a motor vehicle captured using a tachograph and at least one prescribed rule by an indicator appliance independent of the tachograph, comprising:
connecting the indicator appliance by a detachable electromechanical coupling to one of the tachograph and a card reader, the one of the tachograph and the card reader connected to a tachograph data memory of the tachograph having the driving data;
downloading automatically at least one driving data volume element to be examined from the tachograph data memory into an appliance data memory of the indicator appliance;
comparing automatically the at least one driving data volume element with the at least one rule by an appliance microprocessor of the indicator appliance; and
automatically and nonquantitatively transmitting to the indicator appliance by an indicator unit of a discrepancy between the loaded driving data volume element and the rule the indicator appliance as a violation report.

2. The method as claimed in claim 1, wherein the presence of the discrepancy is transmitted to the user visually.

3. The method as claimed in claim 1, wherein the indicator unit automatically and nonquantitatively transmits a correspondence report if there is no discrepancy between the loaded driving data volume element and the rule.

4. The method as claimed in claim 1, wherein at least two different types of discrepancies from rules are provided and in that the violation report is made in a manner differentiated according to type.

5. The method as claimed in claim 1, wherein at least one rule comprises a limit value and the discrepancy from the rule is the limit value being one of exceeded and undershot.

6. The method as claimed in claim 1, further comprising:
connecting the indicator appliance to a data processing apparatus independent of the tachograph before the indicator appliance is connected to the tachograph data memory;
adjusting by the data processing apparatus the at least one rule; and
disconnecting the indicator appliance from the data processing apparatus following the adjustment.

7. The method as claimed in one of the preceding claims, further comprising:
inserting the tachograph data memory configured as a memory card, which can be removed from the tachograph into the card reader and which is independent of the tachograph and of the indicator appliance,
wherein the indicator appliance is connected to the memory card by the card reader.

8. The method as claimed in claim 1, wherein the at least driving data volume element loaded into the indicator appliance is stored in an appliance data memory of the indicator appliance.

9. A system comprising:
a tachograph arranged in a motor vehicle having a tachograph data memory;
an indicator appliance independent of the tachograph having an appliance data memory, an appliance microprocessor and an indicator unit,
wherein the indicator appliance is configured to be connected to the tachograph data memory for automatically downloading driving data for the motor vehicle and to automatically compare the downloaded driving data with a rule and for automatic and nonquantitative transmission of a violation report.

10. The system as claimed in claim 9, wherein the tachograph data memory is a memory card and a card reader is provided that holds the memory card and connection to the indicator appliance.

11. The method as claimed in claim 8, wherein the appliance data memory is an interchangeable memory.
